(19) United States
(12) Patent Application Publication
(10) Pub. No.: US 2026/0331764 A1
(43) Pub. Date: Oct. 22, 2026

(54) ANTENNA DEVICE AND ELECTRONIC APPARATUS

(71) Applicant: UNIVERSAL SCIENTIFIC INDUSTRIAL ( SHANGHAI ) CO., LTD., SHANGHAI (CN)

(72) Inventors: KUAN-HSING LI, SHANGHAI (CN); KUANG-TING CHI, SHANGHAI (CN)

(21) Appl. No.: 19/572,938

(22) Filed: Mar. 20, 2026

(30) Foreign Application Priority Data
Apr. 22, 2025 (CN) 202510512201.8

(51) Int. Cl. H01Q 1/52; H01Q 1/22; H01Q 21/28

(52) U.S. Cl. CPC H01Q 1/526; H01Q 1/22; H01Q 21/28

(57) ABSTRACT

An antenna device and an electronic apparatus. The antenna device includes a substrate assembly, a first metal structure, a second metal structure, a third metal structure, a fourth metal structure, a shield cover, and a frame. The second, third, and fourth metal structures are connected to multiple adjacent inner side walls of the shield cover. One side of the shield cover is closed, and another side of the shield cover is open and has an opening. The frame is connected to the another side of the shield cover having the opening. The substrate assembly is connected to a control circuit for receiving an antenna signal. The antenna signal is transmitted to the first, second, third, and fourth metal structures through signal metal through-holes of the substrate assembly, and is transmitted toward the another side of the shield cover having the opening via the shield cover and the frame.

### CROSS-REFERENCE TO RELATED PATENT APPLICATION

This application claims the benefit of priority to China Patent Application No. 202510512201.8, filed on Apr. 22, 2025, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna device and an electronic apparatus, and more particularly to an antenna device having multiple metal structures and an electronic apparatus using said antenna device.

### BACKGROUND OF THE DISCLOSURE

With the development of the current fifth-generation (5G) mobile communication network, more bandwidths are being expanded for ever-growing digital applications. As such, in the 5G network, apart from limited bandwidths of sub-6 GHz (Frequency Range 1 (FR1)), practicality and universalization of millimeter wave bands (Frequency Range 2 (FR2)) is also important. When a 5G millimeter wave module is disposed in a mobile device, the design of antenna-in-package (AiP) is often adopted. An antenna array can be disposed on a circuit layer below a substrate of the millimeter wave module, and the costs and the volume can be saved by use of a patch antenna. However, the antenna-in-package (AiP) design has problems including a poor antenna frequency and a poor effective bandwidth. In a high frequency development, Band n263, for example, already covers 71 GHz. For the patch antenna that uses a conductor on a printed circuit board as a radiating body, its loss at a high frequency is more obvious due to a substrate medium of the printed circuit board, thereby resulting in poorer antenna efficiency.

In terms of smartphone application, an antenna radiation direction of the antenna-in-package mentioned above is oriented toward a location above an antenna body (i.e., a boresight direction). Hence, the antenna-in-package is usually mounted on a lateral side of the mobile device, thereby causing an antenna signal to be transmitted toward the lateral side of the mobile device. Since a thickness of the lateral side of the mobile device is limited, such configuration significantly limits a width of the antenna-in-package and results in poor heat dissipation performance.

### SUMMARY OF THE DISCLOSURE

In response to the above-referenced technical inadequacies, the present disclosure provides an antenna device and an electronic apparatus.

In order to solve the above-mentioned problems, one of the technical aspects adopted by the present disclosure is to provide an antenna device, which includes a substrate assembly, a first metal structure, a second metal structure, a third metal structure, a fourth metal structure, a shield cover, and a frame. The substrate assembly has a plurality of metal through-holes and at least two signal metal through-holes. The first metal structure is disposed on the substrate assembly. The shield cover is disposed on the substrate assembly, and shields the first metal structure, the second metal structure, the third metal structure, and the fourth metal structure. The second metal structure, the third metal structure, and the fourth metal structure are connected to a plurality of adjacent inner side walls of the shield cover. One side of the shield cover is closed, and another side of the shield cover is open and has an opening. The frame is disposed on the substrate assembly, and is connected to the another side of the shield cover having the opening. The substrate assembly is connected to a control circuit for receiving an antenna signal. The antenna signal is transmitted to the first metal structure, the second metal structure, the third metal structure, and the fourth metal structure through the at least two signal metal through-holes of the substrate assembly, and is transmitted toward the another side of the shield cover having the opening via the shield cover and the frame.

In order to solve the above-mentioned problems, another one of the technical aspects adopted by the present disclosure is to provide an electronic apparatus, which includes a control circuit and at least one antenna device electrically connected to the control circuit for receiving an antenna signal. The at least one antenna device includes a substrate assembly, a first metal structure, a second metal structure, a third metal structure, a fourth metal structure, a shield cover, and a frame. The substrate assembly has a plurality of metal through-holes and at least two signal metal through-holes. The first metal structure is disposed on the substrate assembly. The shield cover is disposed on the substrate assembly, and shields the first metal structure, the second metal structure, the third metal structure, and the fourth metal structure. The second metal structure, the third metal structure, and the fourth metal structure are connected to a plurality of adjacent inner side walls of the shield cover. One side of the shield cover is closed, and another side of the shield cover is open and has an opening. The frame is disposed on the substrate assembly, and is connected to the another side of the shield cover having the opening. The substrate assembly is connected to the control circuit. Through the control circuit and the at least two signal metal through-holes of the substrate assembly, the antenna signal is transmitted to the first metal structure, the second metal structure, the third metal structure, and the fourth metal structure for adjusting a transmission direction and carrying out signal transmission.

In order to solve the above-mentioned problems, yet another one of the technical aspects adopted by the present disclosure is to provide an electronic apparatus, which includes a control circuit, a first antenna device, and a second antenna device. The first antenna device is electrically connected to the control circuit for receiving an antenna signal. The second antenna device is electrically connected to the control circuit for receiving the antenna signal. Each of the first antenna device and the second antenna device includes a substrate assembly, a first metal structure, a second metal structure, a third metal structure, a fourth metal structure, a shield cover, and a frame. The substrate assembly has a plurality of metal through-holes and at least two signal metal through-holes. The first metal structure is disposed on the substrate assembly. The shield cover is disposed on the substrate assembly, and shields the first metal structure, the second metal structure, the third metal structure, and the fourth metal structure. The second metal structure, the third metal structure, and the fourth metal structure are connected to a plurality of adjacent inner side walls of the shield cover. The frame is disposed on the substrate assembly, and is connected to a side of the shield cover having an opening. The substrate assembly is connected to the control circuit. Through the control circuit and the at least two signal metal through-holes of the substrate assembly, the antenna signal is transmitted to the first metal structure, the second metal structure, the third metal structure, and the fourth metal structure for carrying out signal transmission. The antenna signal of the first antenna device is transmitted along a first direction, the antenna signal of the second antenna device is transmitted along a second direction, and the first direction is different from the second direction.

Therefore, in the antenna device and the electronic apparatus provided by the present disclosure, the antenna device of the present disclosure uses the shield cover that adopts a surface-mount technology for changing the antenna signal (a radio frequency signal) from an inner-layer wiring of a multi-layer circuit board in the substrate assembly to a waveguide structure on the substrate assembly. Then, the antenna device of the present disclosure enables transmission of an electromagnetic wave (an electric field vector) of the antenna signal via a four-piece vertical trapezoidal metal sheet structure. When the electromagnetic wave moves in a direction toward the opening of the shield cover, the electric field vector is gradually changed from being in a folded state to having a single polarization direction, such that radiation from the opening of the shield cover can have properties of vertical or horizontal polarization of an antenna. In the present disclosure, the frame made of a metal material is disposed at the opening of the shield cover. In this way, diffraction and reflection of an electric field at an edge of the opening can be prevented, energy reflection can be reduced, an antenna gain can be increased, and directivity can be improved. Furthermore, due to placement of a four-piece metal structure, two feeding ports having two polarization directions in the present disclosure can have improved isolation, symmetry, and impedance matching.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an antenna device according to a first embodiment of the present disclosure;

FIG. 2 is a schematic top view of the antenna device according to the first embodiment of the present disclosure;

FIG. 3 is a schematic cross-sectional view taken along section line III-III of FIG. 2;

FIG. 4 is a schematic cross-sectional view taken along section line IV-IV of FIG. 2;

FIG. 5 is a schematic cross-sectional view taken along section line V-V of FIG. 2;

FIG. 6 is another schematic top view of the antenna device according to the first embodiment of the present disclosure;

FIG. 7 is an electric field distribution diagram (vertical polarization) of the antenna device according to the first embodiment of the present disclosure;

FIG. 8 is an electric field vector diagram taken along section line VIII-VIII of FIG. 7;

FIG. 9 is an electric field distribution diagram (horizontal polarization) of the antenna device according to the first embodiment of the present disclosure;

FIG. 10 is an electric field vector diagram taken along section line X-X of FIG. 9;

FIG. 11 is an S-parameter simulation diagram of a vertical polarization input portion (a first section) of the antenna device according to the first embodiment of the present disclosure;

FIG. 12 is an S-parameter simulation diagram of a horizontal polarization input portion (a shield cover feeding portion) of the antenna device according to the first embodiment of the present disclosure;

FIG. 13 is a diagram illustrating isolation between the horizontal polarization input portion and the vertical polarization input portion of the antenna device according to the first embodiment of the present disclosure;

FIG. 14 is a schematic view illustrating the antenna device in cooperation with a millimeter wave module according to the first embodiment of the present disclosure;

FIG. 15 is another schematic view illustrating the antenna device in cooperation with the millimeter wave module according to the first embodiment of the present disclosure;

FIG. 16 is a schematic view of an electronic apparatus according to a second embodiment of the present disclosure;

FIG. 17 is a schematic view of the electronic apparatus according to a third embodiment of the present disclosure; and

FIG. 18 is a schematic view of the electronic apparatus according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

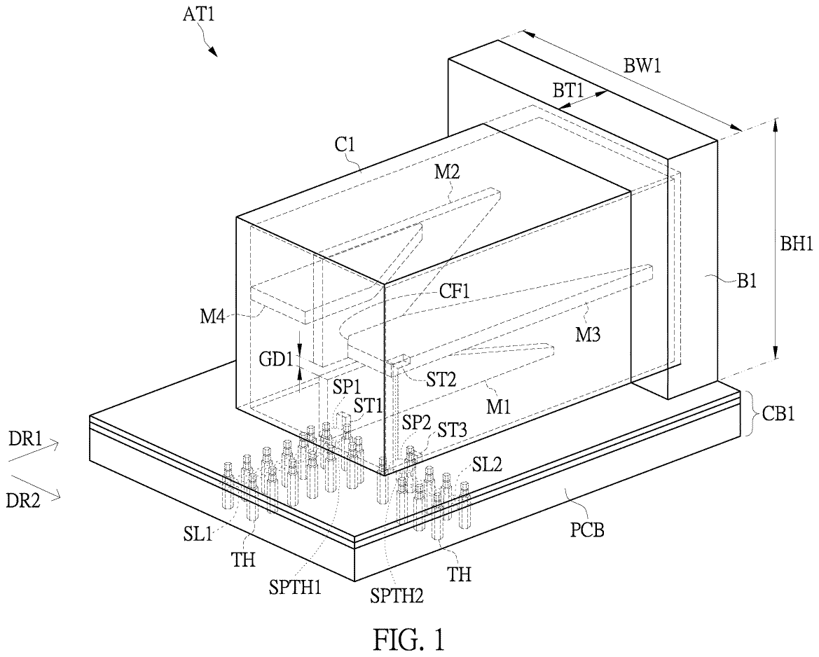

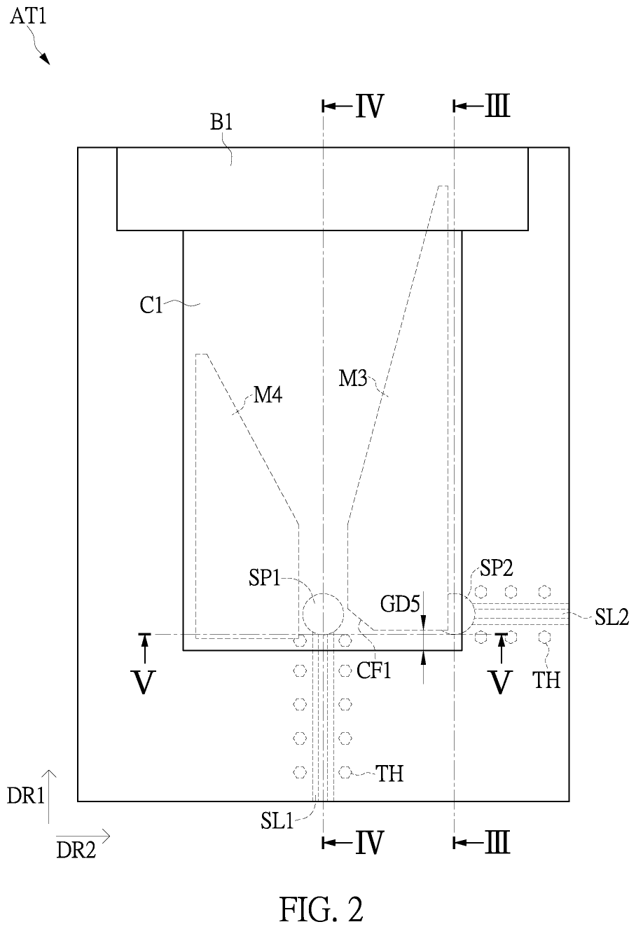

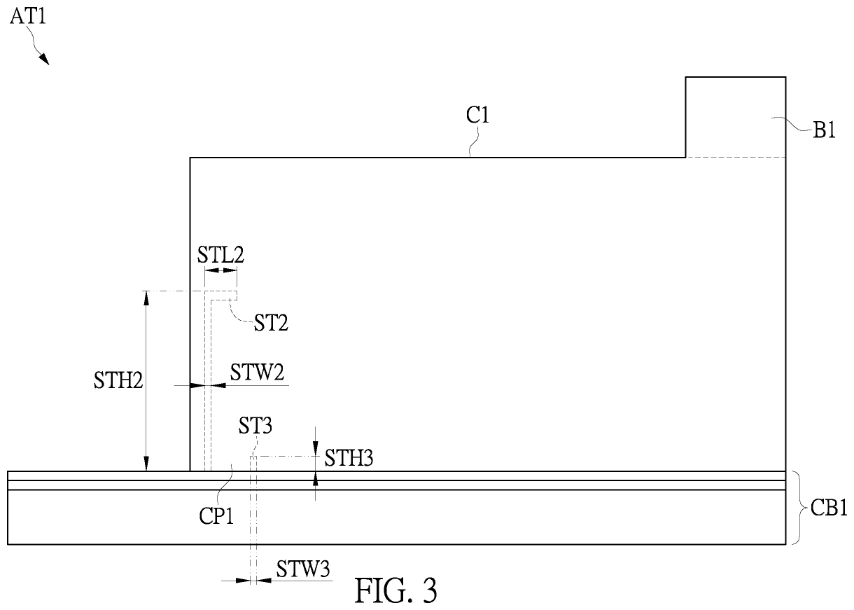

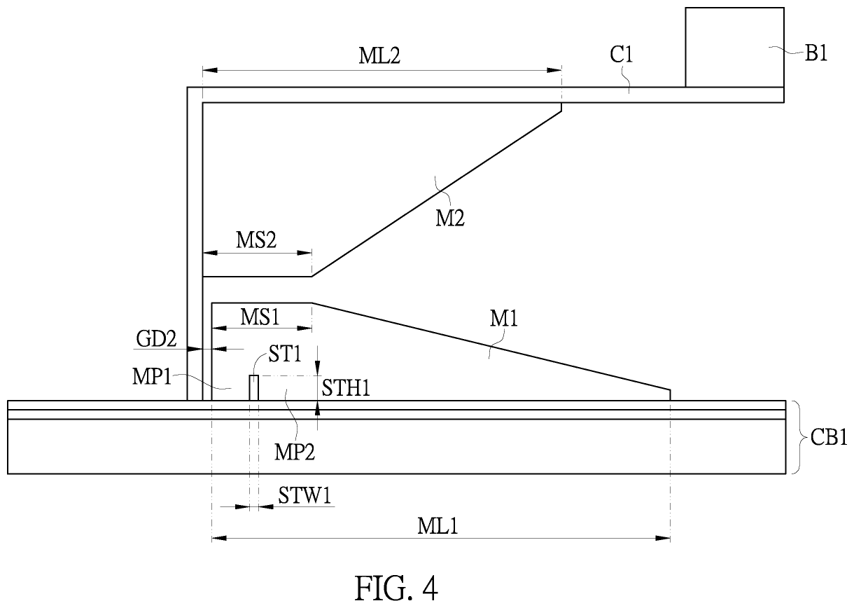

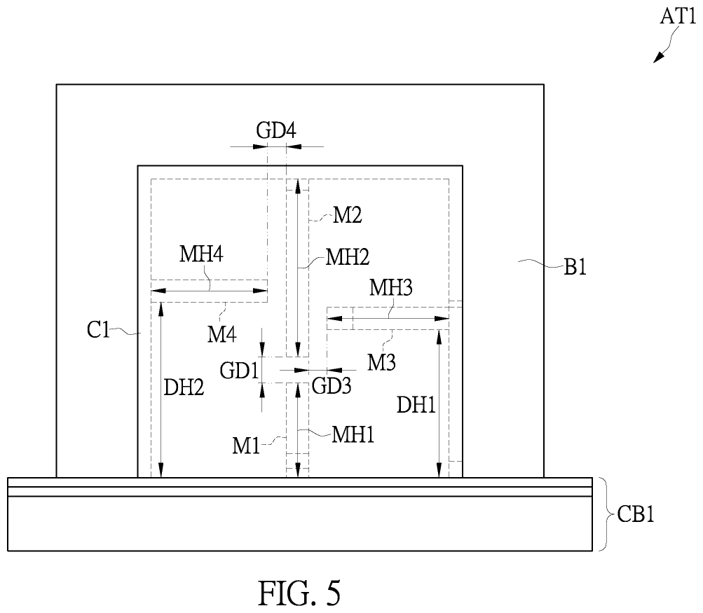

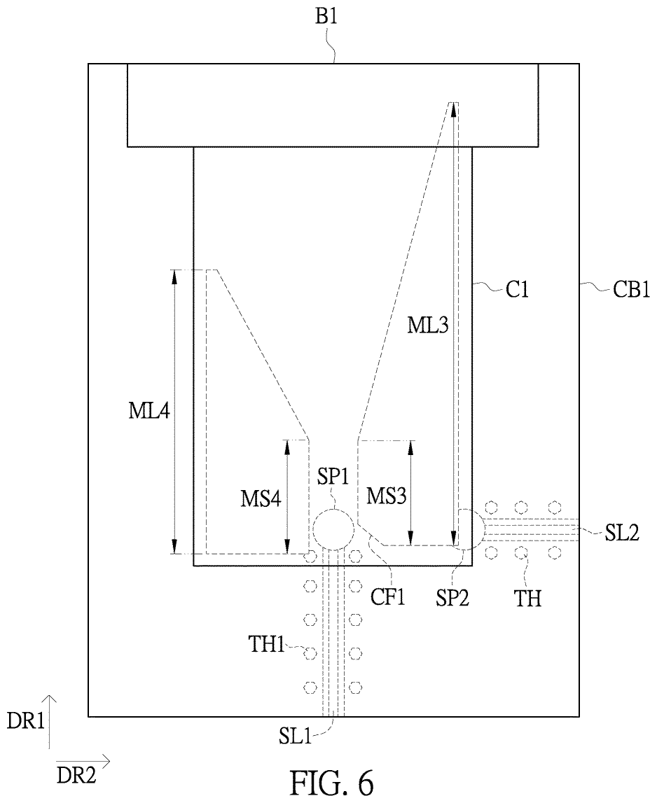

Referring to FIG. 1 to FIG. 6, FIG. 1 is a schematic view of an antenna device according to a first embodiment of the present disclosure, FIG. 2 is a schematic top view of the antenna device according to the first embodiment of the present disclosure, FIG. 3 is a schematic cross-sectional view taken along section line III-III of FIG. 2, FIG. 4 is a schematic cross-sectional view taken along section line IV-IV of FIG. 2, FIG. 5 is a schematic cross-sectional view taken along section line V-V of FIG. 2, and FIG. 6 is another schematic top view of the antenna device according to the first embodiment of the present disclosure.

The present embodiment provides an antenna device AT1.

The antenna device AT1 includes a substrate assembly CB1, a first metal structure M1, a second metal structure M2, a third metal structure M3, a fourth metal structure M4, a shield cover C1, and a frame B1.

The substrate assembly CB1 has a plurality of metal through-holes TH and at least two signal metal through-holes. The first metal structure M1 is disposed on the substrate assembly CB1. In the present embodiment, the at least two signal metal through-holes include a first signal metal through-hole SPTH1 and a second signal metal through-hole SPTH2.

The shield cover C1 is disposed on the substrate assembly CB1, and shields the first metal structure M1, the second metal structure M2, the third metal structure M3, and the fourth metal structure M4. The second metal structure M2, the third metal structure M3, and the fourth metal structure M4 are connected to a plurality of adjacent inner side walls of the shield cover C1. One side of the shield cover C1 is closed, and another side of the shield cover C1 is open and has an opening. The frame B1 is connected to the another side of the shield cover C1 having the opening. In the present embodiment, the shield cover C1 is made of a metal material, and the frame B1 is also made of a metal material. The shield cover C1 and the frame B1 can both be disposed on the substrate assembly CB1 by a surface-mount technology.

The substrate assembly CB1 is connected to a control circuit (not shown in the drawings) for receiving an antenna signal. Through the control circuit (not shown in the drawings) and the first signal metal through-hole SPTH1 and the second signal metal through-hole SPTH2 of the substrate assembly CB1, the antenna signal is transmitted to the first metal structure M1, the second metal structure M2, the third metal structure M3, and the fourth metal structure M4 for adjusting a transmission direction and carrying out signal transmission.

The second metal structure M2 is disposed opposite to the first metal structure M1. A first separation distance GD1 is defined between the first metal structure M1 and the second metal structure M2, and a distance value of the first separation distance GD1 is 0.25 mm.

The third metal structure M3 is disposed opposite to the fourth metal structure M4. The third metal structure M3 is disposed at a first installation position that is spaced apart from the substrate assembly CB1 by a first installation height DH1. A height value of the first installation height DH1 is 1.5 mm. The fourth metal structure M4 is disposed at a second installation position that is spaced apart from the substrate assembly CB1 by a second installation height DH2. A height value of the second installation height DH2 is 1.8 mm. That is, the third metal structure M3 and the fourth metal structure M4 are not arranged to have the same height, but are arranged in a staggered manner and separated by a certain height. A fifth separation distance GD5 is defined between the third metal structure M3 and the inner side wall of the one side of the shield cover C1 that is closed, and a distance value of the fifth separation distance GD5 is 0.1 mm. Furthermore, one end of the third metal structure M3 extends into the frame B1. However, a total length of the third metal structure M3 does not exceed beyond the frame B1.

The first metal structure M1 has a first height MH1, and a height value of the first height MH1 is 0.975 mm. The second metal structure M2 has a second height MH2, and a height value of the second height MH2 is 1.775 mm.

The first metal structure M1 has a first long side ML1 and a first short side MS1, and the first long side ML1 and the first short side MS1 of the first metal structure M1 are disposed opposite to each other. The second metal structure M2 has a second long side ML2 and a second short side MS2, and the second long side ML2 and the second short side MS2 of the second metal structure M2 are disposed opposite to each other. The third metal structure M3 has a third long side ML3 and a third short side MS3, and the third long side ML3 and the third short side MS3 of the third metal structure M3 are disposed opposite to each other. The fourth metal structure M4 has a fourth long side ML4 and a fourth short side MS4, and the fourth long side ML4 and the fourth short side MS4 of the fourth metal structure M4 are disposed opposite to each other.

A length value of the first long side ML1, a length value of the second long side ML2, a length value of the third long side ML3, and a length value of the fourth long side ML4 are different from each other. The length value of the first long side ML1 is greater than the length value of the second long side ML2, and the length value of the third long side ML3 is greater than the length value of the fourth long side ML4.

The length value of the first long side ML1 is 4.6 mm, and a length value of the first short side MS1 is 1 mm. The length value of the second long side ML2 is 3.6 mm, and a length value of the second short side MS2 is 1.1 mm. The length value of the third long side ML3 is 5.3 mm, and a length value of the third short side MS3 is 1.3 mm. The length value of the fourth long side ML4 is 3.4 mm, and a length value of the fourth short side MS4 is 1.4 mm. A front end of each of the first metal structure M1, the second metal structure M2, the third metal structure M3, and the fourth metal structure M4 is a flat cut structure. That is, the basic shape of each of the first metal structure M1, the second metal structure M2, the third metal structure M3, and the fourth metal structure M4 is trapezoidal in the present embodiment, and the first metal structure M1, the second metal structure M2, the third metal structure M3, and the fourth metal structure M4 are metal structures that can be partially adjusted in shape according to the antenna signal and isolation.

A chamfer structure CF1 (0.25 mm) is disposed on the third short side MS3 of the third metal structure M3 adjacent to the one side of the shield cover C1 that is closed. The third metal structure M3 has a third height MH3, and a height value of the third height MH3 is 1.2 mm. The fourth metal structure M4 has a fourth height MH4, and a height value of the fourth height MH4 is 1.2 mm.

The substrate assembly CB1 further includes a multi-layer circuit board PCB, a first pad SP1, a second pad SP2, a first signal stripline SL1, and a second signal stripline SL2. The first signal stripline SL1 and the second signal stripline SL2 are disposed on a middle layer of the multi-layer circuit board PCB, and the first pad SP1 and the second pad SP2 are disposed on an upper layer of the multi-layer printed circuit board PCB.

The first signal stripline SL1 is connected to the first pad SP1 through the first signal metal through-hole SPTH1. The second signal stripline SL2 is connected to the second pad SP2 through the second signal metal through-hole SPTH2. The first pad SP1 is connected to the first metal structure M1, and the second pad SP2 is connected to the third metal structure M3 via the shield cover C1.

The first metal structure M1 has a first notch ST1, and the first notch ST1 is disposed adjacent to the one side of the shield cover C1 that is closed. The first metal structure M1 is divided into a first section MP1 and a second section MP2 by the first notch ST1. The first section MP1 is connected to the first pad SP1 and the first signal stripline SL1 of the substrate assembly CB1. A side of the shield cover C1 that is connected to the third metal structure M3 has a second notch ST2 and a third notch ST3. A shield cover feeding portion CP1 is disposed between the second notch ST2 and the third notch ST3. The shield cover feeding portion CP1 is connected to the second pad SP2 and the second signal stripline SL2. The second notch ST2 is an L-shaped notch that extends from a bottom side of the shield cover C1 to a side of the third metal structure M3. The second notch ST2 has a second notch height STH2, a second notch width STW2, and a second notch extension length STL2. The third notch ST3 has a third notch height STH3 and a third notch width STW3.

A height value of the second notch height STH2 is 1.8 mm, a width value of the second notch width STW2 is 0.1 mm, and a length value of the second notch extension length STL2 is 0.35 mm. A height value of the third notch height STH3 is 0.15 mm, and a width value of the third notch width STW3 is 0.1 mm. A width value of the shield cover feeding portion CP1 is 0.37 mm.

A second separation distance GD2 is defined between the first metal structure M1 and the inner side wall of the one side of the shield cover C1 that is closed, and a distance value of the second separation distance GD2 is 0.1 mm. A third separation distance GD3 is defined between the third metal structure M3 and the second metal structure M2, and a distance value of the third separation distance GD3 is 0.2 mm. A fourth separation distance GD4 is defined between the fourth metal structure M4 and the second metal structure M2, and a distance value of the fourth separation distance GD4 is 0.2 mm.

The frame B1 has a frame width BW1, a frame height BH1, and a frame thickness BT1. A width value of the frame width BW1 is 4.9 mm, a height value of the frame height BH1 is 3.95 mm, and a thickness value of the frame thickness BT1 is 1 mm.

A portion of the metal through-holes TH of the substrate assembly CB1 is arranged along a first direction DR1, and these metal through-holes TH can be arranged into, for example, two parallel rows or two staggered rows. Another portion of the metal through-holes TH of the substrate assembly CB1 is arranged along a second direction DR2, and these metal through-holes TH can be arranged into, for example, two parallel rows or two staggered rows. In the present embodiment, the first direction DR1 is different from the second direction DR2. In other embodiments, the first direction DR1 is perpendicular to the second direction DR2.

In the present embodiment, the distance values, the height values, and the width values mentioned above can all be adjusted according to a frequency of the antenna signal or a ratio from practical requirements, and are not limited in the present disclosure.

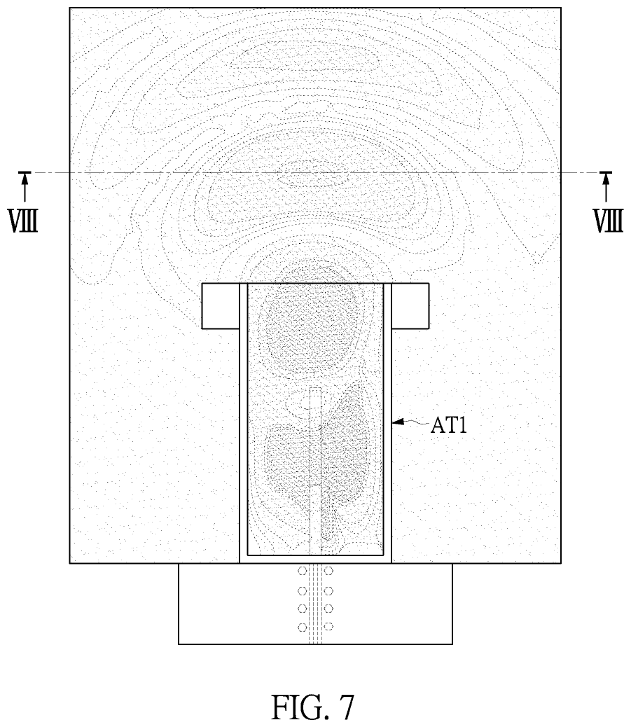

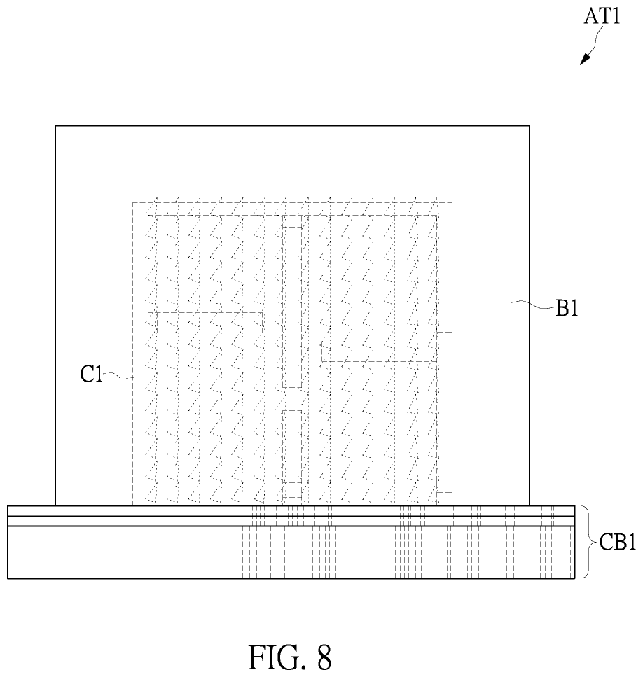

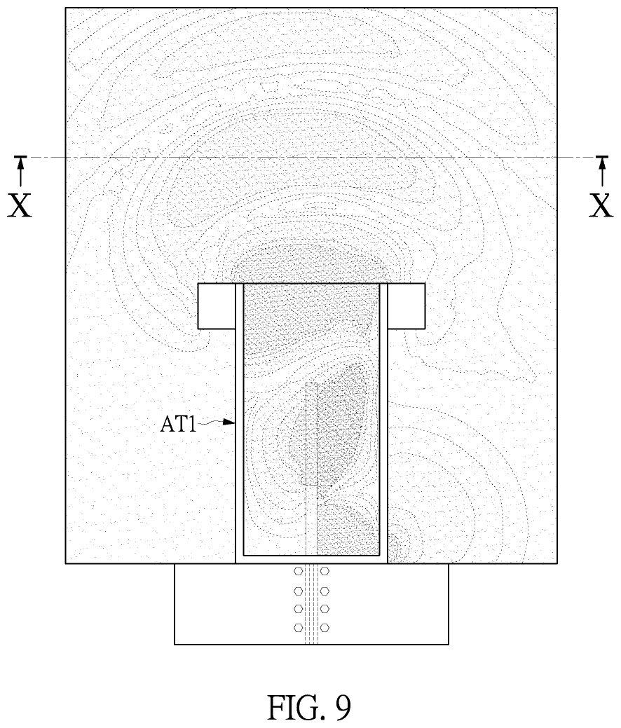

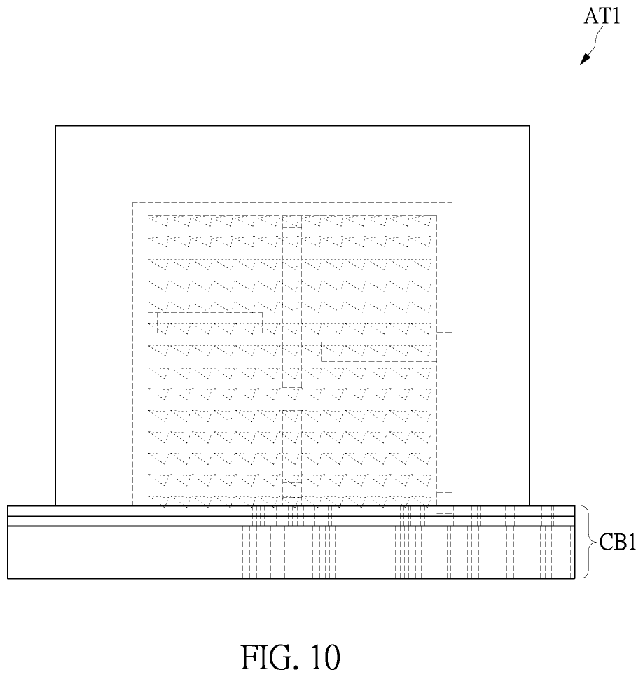

Referring to FIG. 7 to FIG. 10, FIG. 7 is an electric field distribution diagram (vertical polarization) of the antenna device according to the first embodiment of the present disclosure, FIG. 8 is an electric field vector diagram taken along section line VIII-VIII of FIG. 7, FIG. 9 is an electric field distribution diagram (horizontal polarization) of the antenna device according to the first embodiment of the present disclosure, and FIG. 10 is an electric field vector diagram taken along section line X-X of FIG. 9.

The vertical polarization can be identified from the electric field distribution diagram of FIG. 7. When the antenna signal (an electromagnetic wave) is fed into the first signal stripline SL1 in an inner layer, an energy of the antenna signal is transmitted to the first metal structure M1 through the metal through-holes TH. Under the shielding of the shield cover C1, an electric field energy is guided by another three vertical trapezoidal metal sheets, and is radiated into the air after being transmitted to the another side of the shield cover C1 having the opening, so as to form a vertical polarization electric field at an outer side. Reference can be made to the electric field vector diagram of FIG. 8 (which is taken along section line VIII-VIII).

The horizontal polarization can be identified from the electric field distribution diagram of FIG. 9. When the antenna signal (the electromagnetic wave) is fed into the second signal stripline SL2 in the inner layer, the energy of the antenna signal is transmitted to the shield cover feeding portion CP1 at a lateral side of the shield cover C1 through the metal through-holes TH, and is guided to the third metal structure M3 through the L-shaped second notch ST2 of the shield cover C1. Under the shielding of the shield cover C1, the electric field energy is guided by another three vertical trapezoidal metal sheets, and is radiated into the air after being transmitted to the another side of the shield cover C1 having the opening, so as to form a horizontal polarization electric field at the outer side. Reference can be made to the electric field vector diagram of FIG. 10 (which is taken along section line X-X).

A four-piece vertical trapezoidal metal sheet structure (the first metal structure M1, the second metal structure M2, the third metal structure M3, and the fourth metal structure M4) is adopted in the present embodiment. When an electric field moves in a direction toward the opening of the shield cover C1, an electric field vector is gradually changed from being in a folded state to having a single polarization direction (the horizontal polarization or the vertical polarization), such that radiation from the opening of the shield cover C1 can have properties of the common vertical or horizontal polarization of an antenna.

The frame B1 (a metal ring having the shape of an inverted letter “U”) is disposed at the opening of the shield cover C1, so as to prevent diffraction and reflection of the electric field vector at an edge of the opening, reduce energy reflection, increase an antenna gain, and improve directivity.

Referring to FIG. 5 (which is the cross-sectional view taken along section line V-V), the height of the first metal structure M1 is smaller, and the height of the second metal structure M2 (an inverted vertical trapezoidal metal sheet) is greater. A gap between the first metal structure M1 and the second metal structure M2 is lower than the height of the third metal structure M3 and that of the fourth metal structure M4. The third metal structure M3 and the fourth metal structure M4 are disposed at different heights. Such asymmetrical configuration enables two feeding ports having two polarization directions to have improved isolation (approximately 15 dB).

The four vertical trapezoidal metal sheets (the first metal structure M1, the second metal structure M2, the third metal structure M3, and the fourth metal structure M4) are different in length. Such asymmetrical configuration enables a radiation pattern of the antenna device AT1 to have improved symmetry and impedance matching.

The chamfer structure CF1 of the third metal structure M3 can also improve the isolation of the two feeding ports having two polarization directions.

Referring to Table 1 and Table 2 below, Table 1 is a performance table of the vertical polarization of the antenna device AT1 in the present embodiment, and Table 2 is a performance table of the horizontal polarization of the antenna device AT1 in the present embodiment. In the present embodiment, a peak realized gain of the antenna device AT1 can reach 7.5 dBi at 65 GHz. Without taking a feeding end mismatch into consideration, a radiation efficiency can reach 95%.

TABLE 1

| | Vertical polarization (V-Polarization) | |
|---|---|---|
| Frequency | Radiation | Peak Realized |
| (GHz) | Efficiency (%) | Gain (dBi) |
| 57 | 92.7 | 7.05 |
| 65 | 95.0 | 8.38 |
| 71 | 95.5 | 8.16 |

TABLE 2

| | Horizontal polarization (H-Polarization) | |
|---|---|---|
| Frequency | Radiation | Peak Realized |
| (GHz) | Efficiency (%) | Gain (dBi) |
| 57 | 93.3 | 6.82 |
| 65 | 96.0 | 7.54 |
| 71 | 96.5 | 7.47 |

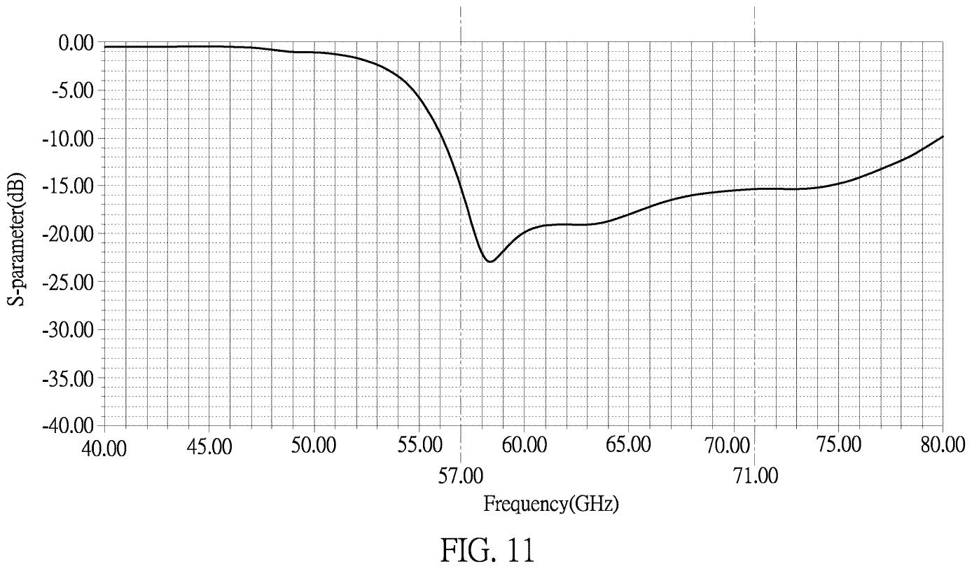

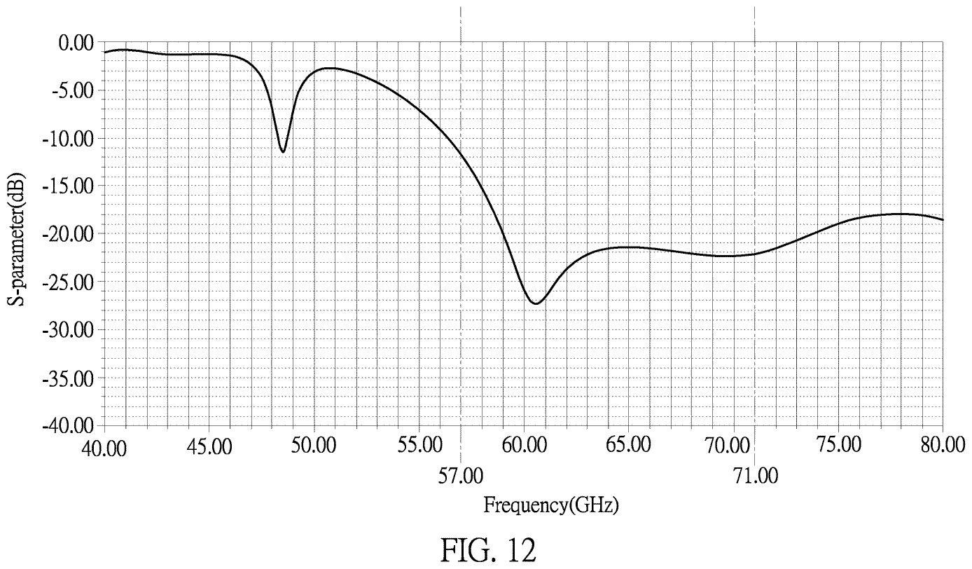

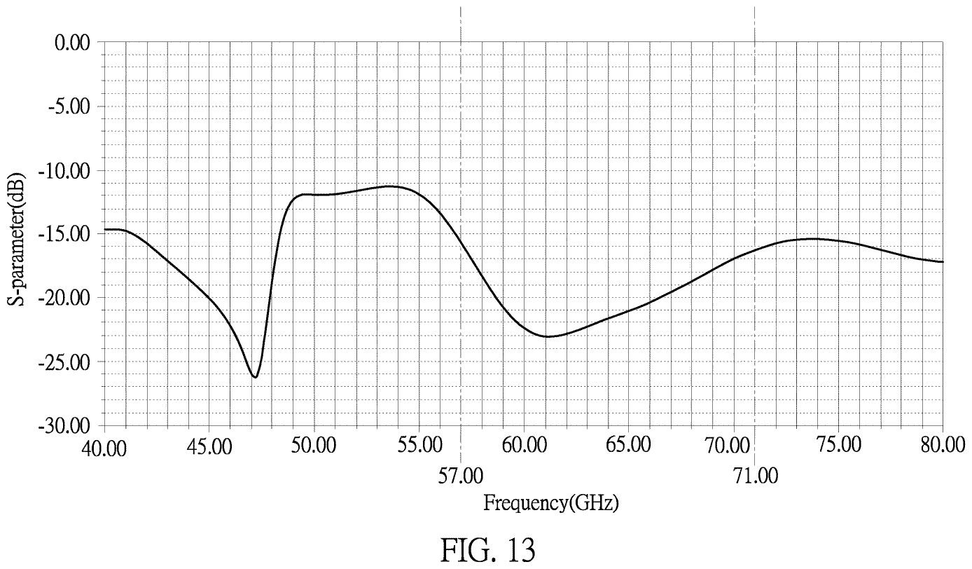

Referring to FIG. 11 to FIG. 13, FIG. 11 is an S-parameter simulation diagram of a vertical polarization input portion (a first section) of the antenna device according to the first embodiment of the present disclosure, FIG. 12 is an S-parameter simulation diagram of a horizontal polarization input portion (a shield cover feeding portion) of the antenna device according to the first embodiment of the present disclosure, and FIG. 13 is a diagram illustrating isolation between the horizontal polarization input portion and the vertical polarization input portion of the antenna device according to the first embodiment of the present disclosure.

It can be clearly observed from S-parameter diagrams of FIG. 11 to FIG. 13 that return losses within Band n263 (57 GHz to 71 GHz) of the newest Frequency Range 2 (FR2) are all above 10 dB in the present embodiment, and isolation between two ports reaches 15 dB. This indicates that the antenna device AT1 of the present embodiment is particularly suitable for application to a 5G millimeter wave or a higher frequency band.

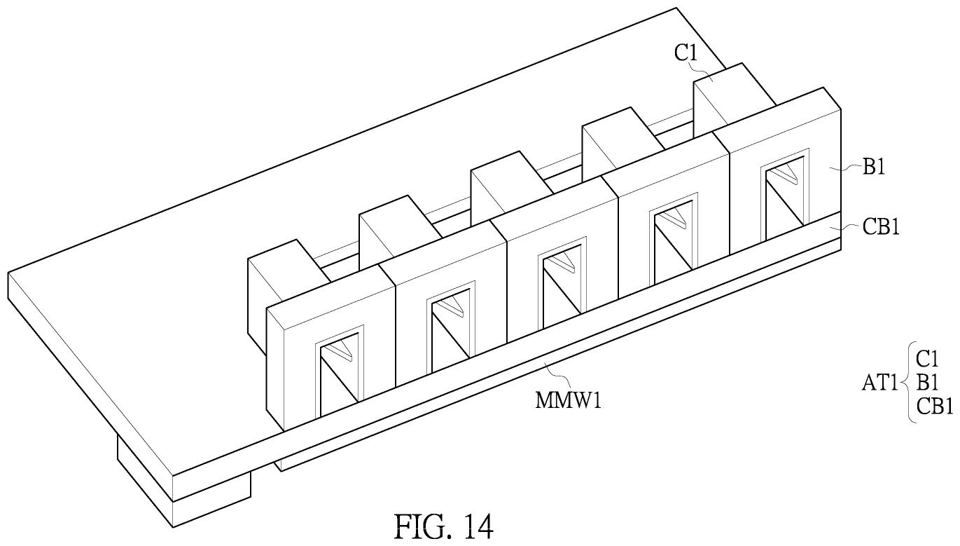

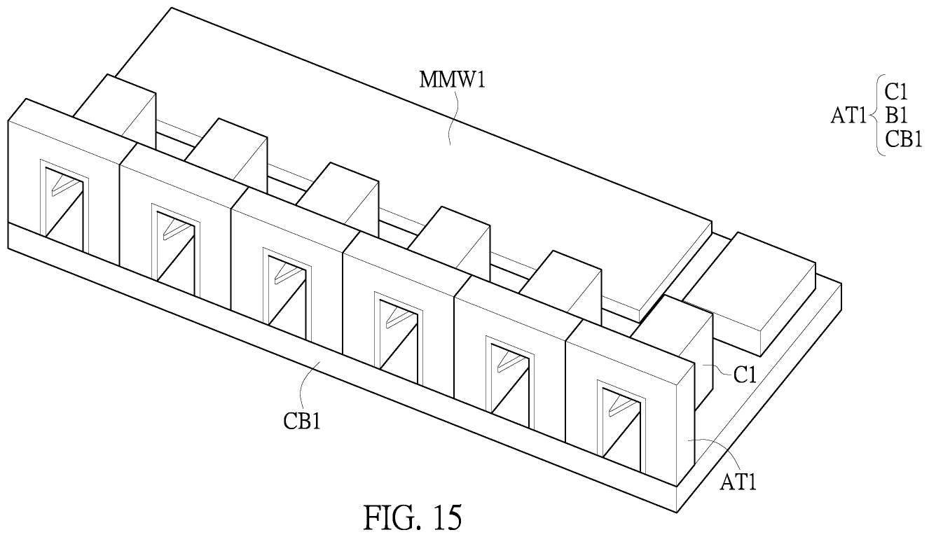

Referring to FIG. 14 and FIG. 15, FIG. 14 is a schematic view illustrating the antenna device in cooperation with a millimeter wave module according to the first embodiment of the present disclosure, and FIG. 15 is another schematic view illustrating the antenna device in cooperation with the millimeter wave module according to the first embodiment of the present disclosure.

In FIG. 14 and FIG. 15, multiple ones of the antenna device AT1 can be disposed adjacent to each other and on the substrate assembly CB1. In addition, a millimeter wave module MMW1 can be disposed on the same side as the antenna devices AT1 (as shown in FIG. 14) or on an opposite side to the antenna devices AT1 (as shown in FIG. 15).

### Second Embodiment

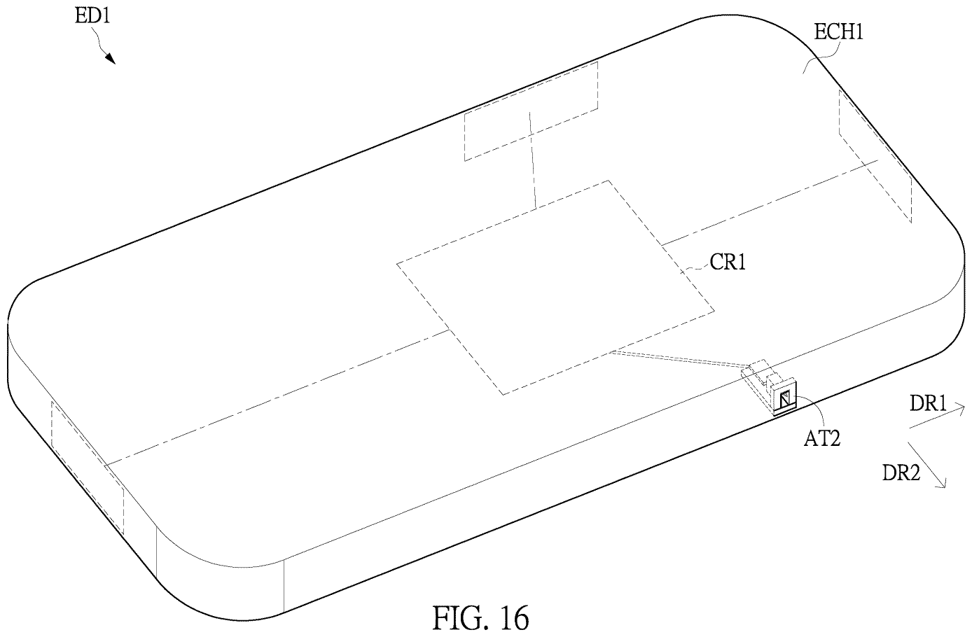

Reference is made to FIG. 16, which is a schematic view of an electronic apparatus according to a second embodiment of the present disclosure.

The present embodiment provides an electronic apparatus ED1.

The electronic apparatus ED1 includes a housing ECH1, a control circuit CR1, and an antenna device AT2. The control circuit CR1 and the antenna device AT2 are disposed in the housing ECH1.

The structure and the function of the antenna device AT2 are the same as those of the antenna device AT1 of the first embodiment, and will not be reiterated herein. The antenna device AT2 is electrically connected to the control circuit CR1 for receiving the antenna signal. The antenna signal can be transmitted according to an installation position and an installation direction of the antenna device AT2.

The electronic apparatus ED1 can be a smartphone, a tablet computer, a wearable electronic device, or a desktop electronic device.

### Third Embodiment

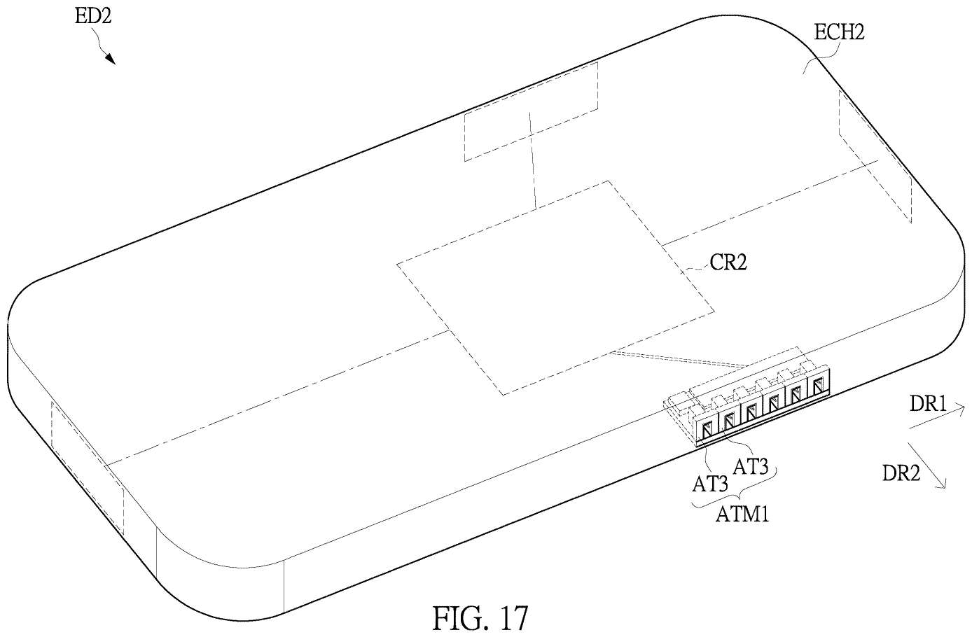

Reference is made to FIG. 17, which is a schematic view of the electronic apparatus according to a third embodiment of the present disclosure.

The present embodiment provides an electronic apparatus ED2.

The electronic apparatus ED2 includes a housing ECH2, a control circuit CR2, and an antenna module ATM1. The antenna module ATM1 and the control circuit CR2 are disposed in the housing ECH2, and the antenna module ATM1 includes a plurality of antenna devices AT3.

The antenna devices AT3 of the antenna module ATM1 are electrically connected to the control circuit CR2 for receiving the antenna signal. The antenna signal can be transmitted according to installation positions and installation directions of the antenna devices AT3.

The structure and the function of the antenna device AT3 of the present embodiment are the same as those of the antenna device AT1 of the first embodiment, and will not be reiterated herein. However, the antenna devices AT3 of the present embodiment are disposed adjacent to each other. For the shield cover C1 and the frame B1 of each of the antenna devices AT3, the opening is oriented toward the same side. Furthermore, due to heights of the antenna devices AT3 in the antenna module ATM1 of the present embodiment being less than 5 mm (i.e., the substrate assembly CB1 (less than 1 mm)+the shield cover C1 (3.1 mm)+the frame B1 (0.8 mm)<5 mm), transmission of the antenna signal at a lateral side of the electronic apparatus ED2 is particularly suitable, and a thickness of the electronic apparatus ED2 will not be increased or affected.

The electronic apparatus ED2 of the present embodiment can be a smartphone, a tablet computer, a wearable electronic device, or a desktop electronic device.

### Fourth Embodiment

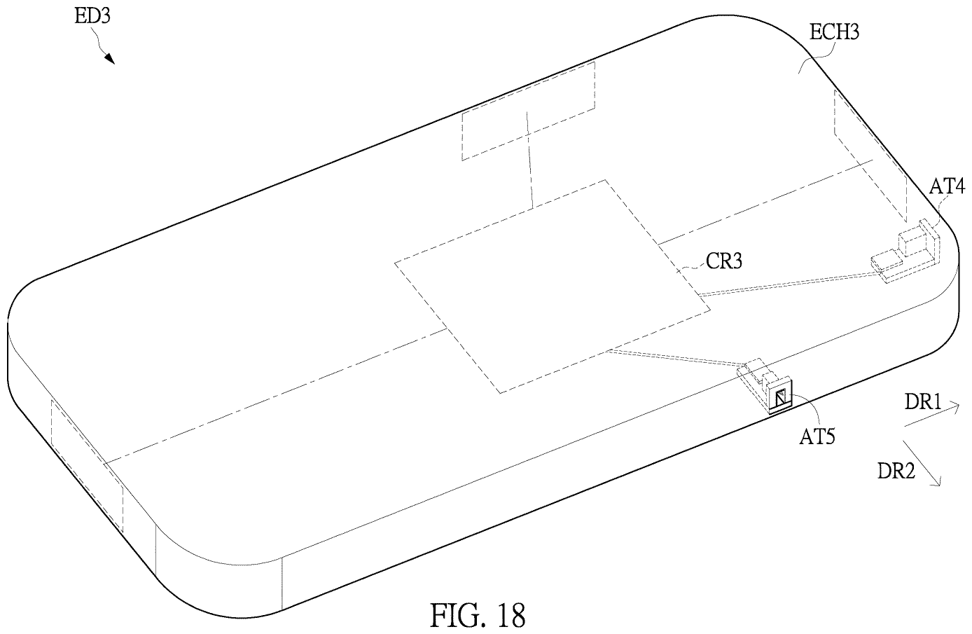

Reference is made to FIG. 18, which is a schematic view of the electronic apparatus according to a fourth embodiment of the present disclosure.

The present embodiment provides an electronic apparatus ED3.

The electronic apparatus ED3 includes a housing ECH3, a control circuit CR3, a first antenna device AT4, and a second antenna device AT5.

In the present embodiment, the first antenna device AT4 and the second antenna device AT5 are electrically connected to the control circuit CR3 for receiving the antenna signal. The structure and the function of the first antenna device AT4 and the second antenna device AT5 are similar to those of the antenna device AT1 of the first embodiment, and will not be reiterated herein. However, in the present embodiment, an installation direction of the first antenna device AT4 is different from that of the second antenna device AT5. The shield cover C1 and the frame B1 of the first antenna device AT4 are oriented toward the first direction DR1, and the opening of the shield cover C1 and the frame B1 of the second antenna device AT5 is oriented toward the second direction DR2. That is, the antenna signal can be transmitted from the first antenna device AT4 that is oriented toward the first direction DR1, and can also be transmitted from the second antenna device AT5 that is oriented toward the second direction DR2, such that possibilities for a transmission direction of the antenna signal can be expanded. In other embodiments, the first antenna device AT4 and the second antenna device AT5 can respectively receive antenna signals of different modules, so as to carry out signal transmission in different directions.

### Beneficial Effects of the Embodiments

In conclusion, in the antenna device and the electronic apparatus provided by the present disclosure, the antenna device of the present disclosure uses a shield cover that adopts a surface-mount technology for changing an antenna signal (a radio frequency signal) from an inner-layer wiring of a multi-layer circuit board in a substrate assembly to a waveguide structure on the substrate assembly. Then, the antenna device of the present disclosure enables transmission of an electromagnetic wave (an electric field vector) of the antenna signal via a four-piece vertical trapezoidal metal sheet structure. When the electromagnetic wave moves in a direction toward an opening of the shield cover, the electric field vector is gradually changed from being in a folded state to having a single polarization direction, such that radiation from the opening of the shield cover can have properties of vertical or horizontal polarization of an antenna. In the present disclosure, a frame made of a metal material is disposed at the opening of the shield cover. In this way, diffraction and reflection of an electric field at an edge of the opening can be prevented, energy reflection can be reduced, an antenna gain can be increased, and directivity can be improved. Furthermore, due to placement of a four-piece metal structure, two feeding ports having two polarization directions in the present disclosure can have improved isolation, symmetry, and impedance matching.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna device, comprising:
a substrate assembly having a plurality of metal through-holes and at least two signal metal through-holes;
a first metal structure disposed on the substrate assembly;
a second metal structure;
a third metal structure;
a fourth metal structure;
a shield cover disposed on the substrate assembly, wherein the shield cover shields the first metal structure, the second metal structure, the third metal structure, and the fourth metal structure, the second metal structure, the third metal structure, and the fourth metal structure are connected to a plurality of adjacent inner side walls of the shield cover, one side of the shield cover is closed, and another side of the shield cover is open and has an opening; and
a frame disposed on the substrate assembly, wherein the frame is connected to the another side of the shield cover having the opening;
wherein the substrate assembly is connected to a control circuit for receiving an antenna signal; and wherein the antenna signal is transmitted to the first metal structure, the second metal structure, the third metal structure, and the fourth metal structure through the at least two signal metal through-holes of the substrate assembly, and is transmitted toward the another side of the shield cover having the opening via the shield cover and the frame.

2. The antenna device according to claim 1, wherein the second metal structure is disposed opposite to the first metal structure, and a first separation distance is defined between the first metal structure and the second metal structure.

3. The antenna device according to claim 2, wherein the third metal structure is disposed opposite to the fourth metal structure, the third metal structure is disposed at a first installation position that is spaced apart from the substrate assembly by a first installation height, the fourth metal structure is disposed at a second installation position that is spaced apart from the substrate assembly by a second installation height, and the first installation height is different from the second installation height; and wherein a third separation distance is defined between the third metal structure and the second metal structure, and a fourth separation distance is defined between the fourth metal structure and the second metal structure.

4. The antenna device according to claim 3, wherein the first metal structure has a first long side and a first short side, the first long side and the first short side of the first metal structure are disposed opposite to each other, the second metal structure has a second long side and a second short side, the second long side and the second short side of the second metal structure are disposed opposite to each other, the third metal structure has a third long side and a third short side, the third long side and the third short side of the third metal structure are disposed opposite to each other, the fourth metal structure has a fourth long side and a fourth short side, the fourth long side and the fourth short side of the fourth metal structure are disposed opposite to each other, and a length value of the first long side, a length value of the second long side, a length value of the third long side, and a length value of the fourth long side are different from each other.

5. The antenna device according to claim 4, wherein the length value of the first long side is greater than the length value of the second long side, and the length value of the third long side is greater than the length value of the fourth long side.

6. The antenna device according to claim 5, wherein a chamfer structure is disposed on the third short side of the third metal structure adjacent to the one side of the shield cover that is closed, and a fifth separation distance is defined between the third metal structure and the inner side wall of the one side of the shield cover that is closed.

7. The antenna device according to claim 6, wherein the substrate assembly further includes a first pad, a second pad, a first signal stripline, and a second signal stripline, the first signal stripline is connected to the first pad, the second signal stripline is connected to the second pad, the first pad is connected to the first metal structure, and the second pad is connected to the third metal structure.

8. The antenna device according to claim 7, wherein the first metal structure has a first notch, the first notch is disposed adjacent to the one side of the shield cover that is closed, the first metal structure is divided into a first section and a second section by the first notch, the first section is connected to the first pad and the first signal stripline of the substrate assembly, a side of the shield cover that is connected to the third metal structure has a second notch and a third notch, a shield cover feeding portion is disposed between the second notch and the third notch, and the shield cover feeding portion is connected to the second pad and the second signal stripline.

9. The antenna device according to claim 8, wherein a second separation distance is defined between the first metal structure and the inner side wall of the one side of the shield cover that is closed.

10. The antenna device according to claim 9, wherein the frame has a frame width, a frame height, and a frame thickness, a width value of the frame width is 4.9 mm, a height value of the frame height is 3.95 mm, and a thickness value of the frame thickness is 1 mm; wherein a distance value of the second separation distance between the first metal structure and the inner side wall of the shield cover is 0.1 mm, the first metal structure has a first height, a height value of the first height is 0.975 mm, the second metal structure has a second height, a height value of the second height is 1.775 mm, the third metal structure has a third height, a height value of the third height is 1.2 mm, the fourth metal structure has a fourth height, and a height value of the fourth height is 1.2 mm; wherein the length value of the first long side is 4.6 mm, a length value of the first short side is 1 mm, the length value of the second long side is 3.6 mm, a length value of the second short side is 1.1 mm, the length value of the third long side is 5.3 mm, a length value of the third short side is 1.3 mm, the length value of the fourth long side is 3.4 mm, and a length value of the fourth short side is 1.4 mm; and wherein the first separation distance is 0.25 mm, a height value of the first installation height is 1.5 mm, a height value of the second installation height is 1.8 mm, a distance value of the third separation distance is 0.2 mm, a distance value of the fourth separation distance is 0.2 mm, and a distance value of the fifth separation distance is 0.1 mm.

11. The antenna device according to claim 10, wherein a portion of the plurality of metal through-holes of the substrate assembly is arranged along a first direction, and another portion of the plurality of metal through-holes of the substrate assembly is arranged along a second direction.

12. An electronic apparatus, comprising:
a control circuit; and
at least one antenna device electrically connected to the control circuit for receiving an antenna signal, wherein the at least one antenna device includes:
a substrate assembly having a plurality of metal through-holes and at least two signal metal through-holes;
a first metal structure disposed on the substrate assembly;
a second metal structure;
a third metal structure;
a fourth metal structure;
a shield cover disposed on the substrate assembly, wherein the shield cover shields the first metal structure, the second metal structure, the third metal structure, and the fourth metal structure, the second metal structure, the third metal structure, and the fourth metal structure are connected to a plurality of adjacent inner side walls of the shield cover, one side of the shield cover is closed, and another side of the shield cover is open and has an opening; and
a frame disposed on the substrate assembly, wherein the frame is connected to the another side of the shield cover having the opening;
wherein the substrate assembly is connected to the control circuit for receiving the antenna signal; and wherein the antenna signal is transmitted to the first metal structure, the second metal structure, the third metal structure, and the fourth metal structure through the at least two signal metal through-holes of the substrate assembly, and is transmitted toward the another side of the shield cover having the opening via the shield cover and the frame.

13. An electronic apparatus, comprising:
a control circuit;
a first antenna device electrically connected to the control circuit for receiving an antenna signal; and
a second antenna device electrically connected to the control circuit for receiving the antenna signal;
wherein each of the first antenna device and the second antenna device includes:
a substrate assembly having a plurality of metal through-holes and at least two signal metal through-holes;
a first metal structure disposed on the substrate assembly;
a second metal structure;
a third metal structure;
a fourth metal structure;
a shield cover disposed on the substrate assembly, wherein the shield cover shields the first metal structure, the second metal structure, the third metal structure, and the fourth metal structure, the second metal structure, the third metal structure, and the fourth metal structure are connected to a plurality of adjacent inner side walls of the shield cover, one side of the shield cover is closed, and another side of the shield cover is open and has an opening; and
a frame disposed on the substrate assembly, wherein the frame is connected to the another side of the shield cover having the opening;
wherein the substrate assembly is connected to the control circuit for receiving the antenna signal; and wherein the antenna signal is transmitted to the first metal structure, the second metal structure, the third metal structure, and the fourth metal structure through the at least two signal metal through-holes of the substrate assembly, and is transmitted toward the another side of the shield cover having the opening via the shield cover and the frame;
wherein the antenna signal of the first antenna device is transmitted along a first direction, the antenna signal of the second antenna device is transmitted along a second direction, and the first direction is different from the second direction.
